(19) United States
(12) Patent Application Publication
(10) Pub. No.: US 2024/0100490 A1
(43) Pub. Date: Mar. 28, 2024

(54) POLYFLUORENE-BASED ANION EXCHANGE COMPOSITE MEMBRANE AND METHOD FOR PREPARING SAME

(71) Applicant: IUCF-HYU (INDUSTRY-UNIVERSITY COOPERATION FOUNDATION HANYANG UNIVERSITY), Seoul (KR)

(72) Inventors: Young Moo LEE, Seoul (KR); Nanjun CHEN, Seoul (KR); Jong Hyeong PARK, Seoul (KR); Ho Hyun WANG, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/268,454

(22) PCT Filed: Dec. 9, 2021
(86) PCT No.: PCT/KR2021/018582

§ 371 Date: Jun. 20, 2023

(30) Foreign Application Priority Data
Dec. 18, 2020 (KR) 10-202-0178395
Nov. 30, 2021 (KR) 10-2021-0168178

(51) Int. Cl. B01D 71/58; B01D 69/10; B01D 69/12

(52) U.S. Cl. CPC B01D 71/58; B01D 69/107; B01D 69/1214; B01D 2323/30; B01D 2323/46; B01D 2323/52; B01D 2325/02833

(57) ABSTRACT

The present disclosure relates to a technology of preparing an anion exchange composite membrane including: a porous polymer support; and a polyfluorene-based anion exchange membrane or a polyfluorene-based anion exchange membrane having a cross-linked structure formed on the support, and applying the same to alkaline fuel cells, water electrolysis, carbon dioxide reduction, metal-air batteries, etc. The polyfluorene-based anion exchange composite membrane including a porous polymer support according to the present disclosure has remarkably improved mechanical properties, dimensional stability, durability, long-term stability, etc.

### TECHNICAL FIELD

The present disclosure relates to a polyfluorene-based anion exchange composite membrane and a method for preparing the same, more particularly to a technology of preparing an anion exchange composite membrane including: a porous polymer support; and a polyfluorene-based anion exchange membrane or a polyfluorene-based anion exchange membrane having a cross-linked structure impregnated in the porous polymer support, and applying the same to alkaline fuel cells, water electrolysis, carbon dioxide reduction, metal-air batteries, etc.

### Background Art

Polymer electrolyte membrane fuel cells (PEMFCs) have been studied a lot due to the advantages of relatively high current density and environmental friendliness. Especially, proton exchange membranes based on perfluorohydrocarbons represented by Nafion have been mainly used as the polymer electrolyte membranes. Although the Nafion membrane has superior chemical stability and high ionic conductivity, it is very costly and has a low glass transition temperature. Therefore, researches are being conducted actively to replace Nafion, including the development of aromatic hydrocarbon-based polymer electrolyte membranes, etc.

Recently, alkaline membrane fuel cells (AMFCs) that use anion exchange membranes and are operated under alkaline environment are drawing attentions. Especially, the alkaline membrane fuel cells are being researched continuously because inexpensive nonprecious metals such as nickel, manganese, etc. can be used as electrode catalysts instead of platinum and they exhibit superior performance and remarkably high cost competitiveness as compared to the polymer electrolyte membrane fuel cells.

For anion exchange membranes for application to alkaline membrane fuel cells, polymers having aryl ether main chains such as polyarylethersulfone, polyphenylether, polyetheretherketone, etc. have been mainly used. In addition, although cross-linked anion exchange membranes using hydrophobic crosslinking agents such as 1,5-dibromopentane, 1,6-dibromohexane and 1,6-hexanediamine are known, the hydrophobic anion exchange membranes have the problems of low ionic conductivity, limited flexibility, low solubility, etc. to be used for anion exchange fuel cells. In addition, because the existing anion exchange membranes are limited in terms of chemical stability (less than 500 hours in 1 M NaOH solution at 80° C.) and mechanical properties (tensile strength<30 MPa), power density is low (0.1-0.5 Wcm⁻²) and battery durability is decreased when they are used for fuel cells.

In addition, the existing anion exchange membranes have poor dimensional stability due to high water uptake and swelling ratio. It is known that these unsatisfactory physical properties originate from the fact that anion exchange membranes are mostly in the form of single membranes. In addition, because the anion exchange composite membranes have the problem that a porous support is not easily impregnated in a polymer solution during the preparation process, improvement is necessary therefor.

The inventors of the present disclosure have researched consistently to expand the applications of aromatic polymer ion exchange membranes having superior thermal and chemical stability and mechanical properties. As a result, they have noticed that a composite membrane prepared by forming an anion exchange membrane obtained from a polyfluorene-based copolymer or a polyfluorene-based copolymer having a cross-linked structure, which has no aryl ether bond in a polymer backbone and has a piperidinium group introduced in a repeating unit, on a porous polymer support has remarkably improved mechanical properties, dimensional stability, durability, long-term stability, etc. and can be commercialized, and have completed the present disclosure.

[References of Related Art]

### PATENT DOCUMENTS

Patent document 1. Korean Patent Publication No. 10-2018-0121961.
Patent document 2. International Patent Publication No. WO 2019/068051.
Patent document 3. Chinese Patent Registration No. CN 106784946.
Patent document 4. Chinese Patent Registration No. CN 108164724.

### DISCLOSURE

### Technical Problem

The present disclosure is directed to providing a polyfluorene-based anion exchange composite membrane with remarkably improved mechanical properties, dimensional stability, durability, long-term stability, etc., and a method for preparing the same.

The present disclosure is also directed to applying the polyfluorene-based anion exchange composite membrane to alkaline fuel cells, water electrolysis, carbon dioxide reduction and metal-air batteries.

### Technical Solution

The present disclosure provides a polyfluorene-based anion exchange composite membrane including: a porous polymer support; and a polyfluorene-based anion exchange membrane or a polyfluorene-based anion exchange membrane having a cross-linked structure impregnated in the porous polymer support.

The porous polymer support is selected from a group consisting of polyethylene, polypropylene, polytetrafluoroethylene, polyvinylidene fluoride, polyhexafluoropropylene and poly(perfluoroalkyl vinyl ether). The porous polymer support has a pore size of 0.01-0.5 μm and a porosity of 50-90%.

The porous polymer support is fluorinated or hydrophilized. The polyfluorene-based anion exchange membrane is a polyfluorene-based copolymer ionomer having a repeating unit represented by <Chemical Formula 1>.

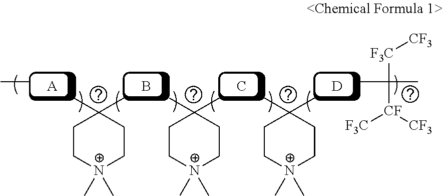

In Chemical Formula 1,

each of A, B, C and D segments is independently a compound selected from the following formulas, which may be identical to or different from each other:

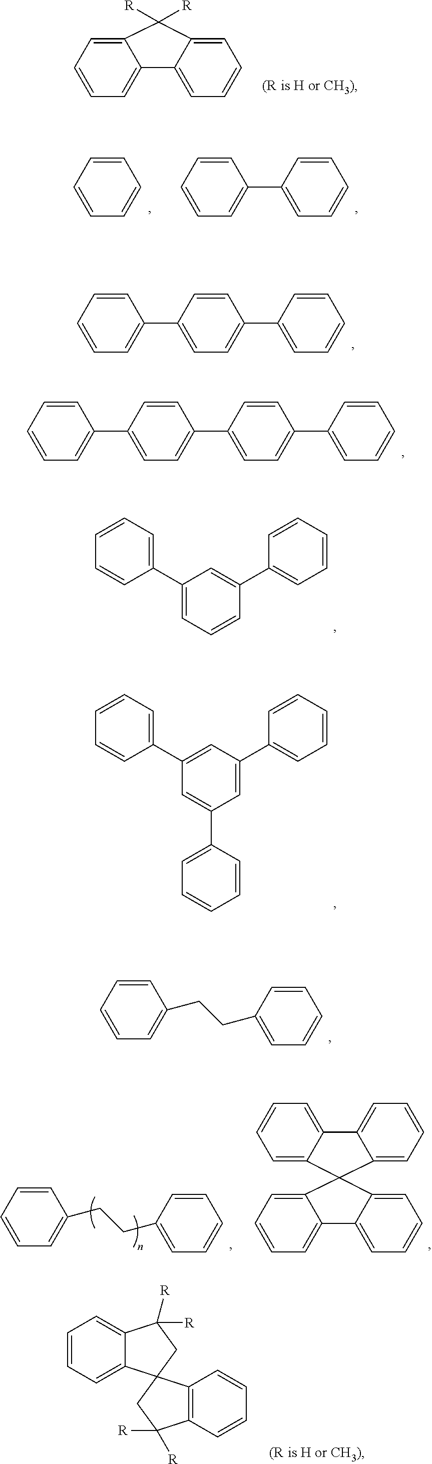

at least one of them being

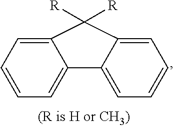

and

x, y, z and m are molar ratios in the repeating unit of the polymer ionomer x+y+z+m=1).

The polyfluorene-based anion exchange membrane having a cross-linked structure is a polyfluorene-based cross-linked copolymer selected from copolymers having a cross-linked structure represented by <Chemical Formula 2> to <Chemical

Formula 6>.

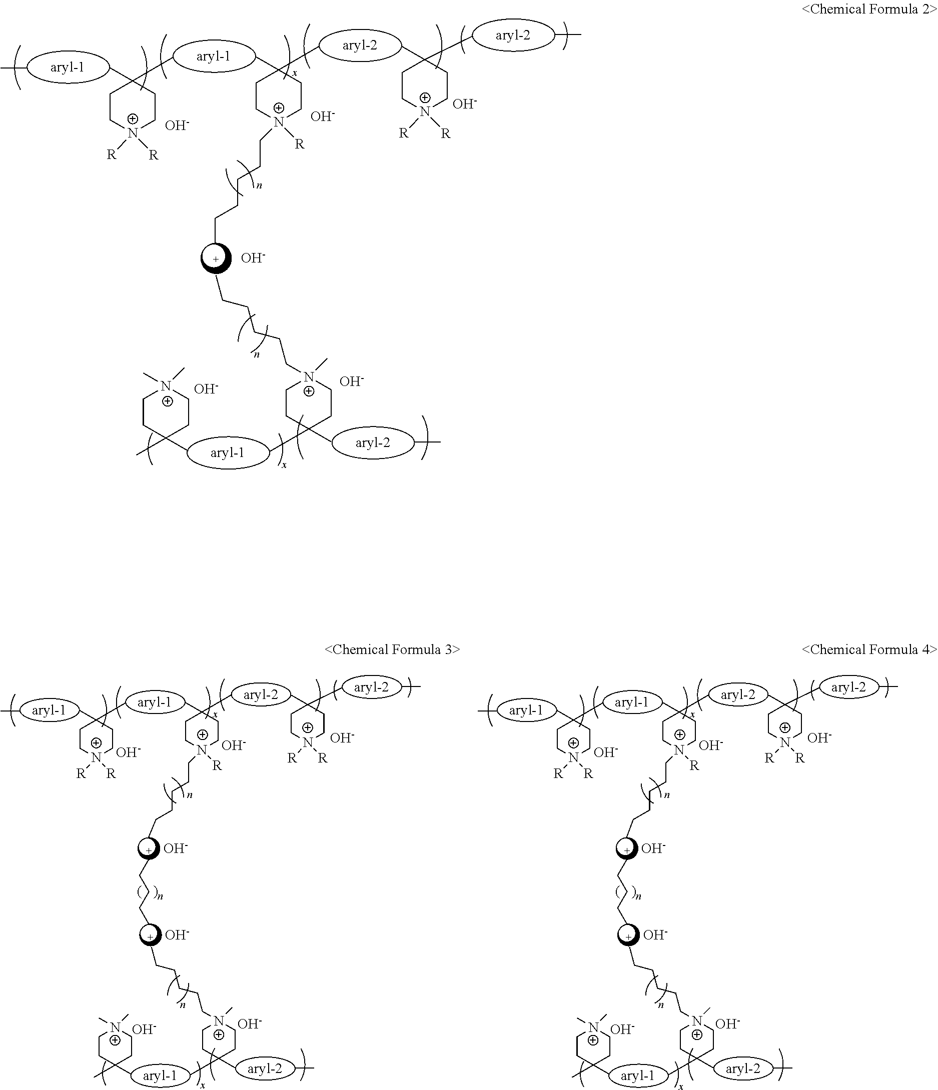

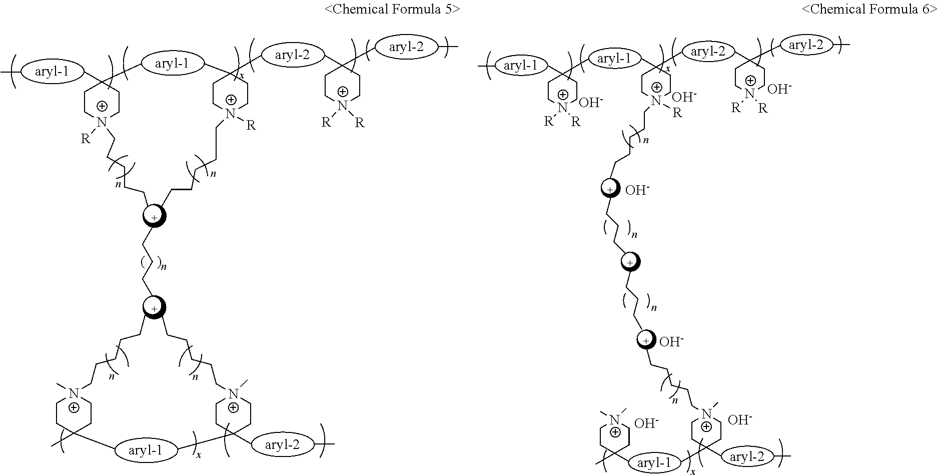

In <Chemical Formula 2> to <Chemical Formula 6>,

each of aryl-1 and aryl-2 is independently selected from a group consisting of fluorenyl, phenyl, biphenyl, terphenyl and quaterphenyl, at least one of them being fluorenyl,

R is H or CH₃,

x indicates crosslinking degree,

[symbol] indicates an ammonium-based crosslinking agent,

n is an integer from 1 to 15.

The present disclosure also provides a method for preparing a polyfluorene-based anion exchange composite membrane, which includes: (I) a step of preparing a porous polymer support; (II) a step of obtaining an ionomer solution by adding a cosolvent to a polymer solution wherein the polyfluorene-based copolymer represented by <Chemical Formula 1> or the polyfluorene-based cross-linked copolymer selected from those represented by <Chemical Formula 2> to <Chemical Formula 6> is dissolved in an organic solvent; and (III) a step of casting the ionomer solution on a porous polymer support and then impregnating and drying the same.

The surface of the porous polymer support of the step (I) is fluorinated or hydrophilized.

The organic solvent of the step (II) is N-methylpyrrolidone, dimethylacetamide, dimethyl sulfoxide or dimethylformamide.

The cosolvent of the step (II) is methanol, ethanol or isopropyl alcohol.

The amount of the cosolvent added in the step (II) is 2-25 wt % based on the polymer solution.

The present disclosure also provides a membrane electrode assembly for an alkaline fuel cell, which includes the polyfluorene-based anion exchange composite membrane.

The present disclosure also provides an alkaline fuel cell including the polyfluorene-based anion exchange composite membrane.

The present disclosure also provides a water electrolysis device including the polyfluorene-based anion exchange composite membrane.

### Advantageous Effects

A polyfluorene-based anion exchange composite membrane including a porous polymer support according to the present disclosure has remarkably improved mechanical properties, dimensional stability, durability, long-term stability, etc.

In addition, the polyfluorene-based anion exchange composite membrane including a porous polymer support of the present disclosure can be applied to alkaline fuel cells, water electrolysis devices, carbon dioxide reduction, metal-air batteries, etc.

In addition, according to a method for preparing an anion exchange composite membrane according to the present disclosure, large-scale production is possible because the degree of impregnation of an ionomer polymer solution by surface-treating the support and using a cosolvent is improved.

### BRIEF DESCRIPTION OF DRAWINGS

FIG. 1 shows the photographic image of a polyfluorene-based anion exchange composite membrane obtained according to an exemplary embodiment of the present disclosure.

FIG. 2A to 2C show the transmittance of anion exchange composite membranes prepared in Examples 1-3, an anion exchange membrane prepared in Comparative Example 1 and a porous polyethylene support as a control group (thickness=20 μm) [UV transmittance measurement result (FIG. 2A), photographic images (FIG. 2B), scanning electron microscopy (SEM) images (FIG. 2C)].

FIG. 3 shows the surface and cross-sectional scanning electron microscopy (SEM) images of an anion exchange composite membrane prepared in Example 2.

FIG. 4 shows the mechanical properties of anion exchange composite membranes prepared in Examples 2-5, an anion exchange membrane prepared in Comparative Example 1, an anion exchange composite membrane prepared in Comparative Example 2 and a porous polyethylene support as a control group.

FIG. 5 shows the thermogravimetric analysis (TGA) result showing the thermal stability of an anion exchange composite membrane prepared in Example 2, an anion exchange composite membrane prepared in Comparative Example 2 and a porous polyethylene support as a control group.

FIG. 6 shows the dimensional stability of an anion exchange composite membrane prepared in Example 3 and an anion exchange membrane prepared in Comparative Example 1.

FIG. 7 shows the hydrogen permeability and water permeability of an anion exchange composite membrane prepared in Example 2, an anion exchange membrane prepared in Comparative Example 1 and a commercial anion exchange membrane (FAA-3-50) as a control group.

FIG. 8 shows the fuel cell performance of an anion exchange composite membrane prepared in Example 2 and anion exchange composite membranes prepared in Comparative Examples 2 and 3.

FIG. 9 shows the fuel cell performance of an anion exchange composite membrane prepared in Example 1 and an anion exchange membrane prepared in Comparative Example 1.

### BEST MODE

Hereinafter, a polyfluorene-based anion exchange composite membrane and a method for preparing the same according to the present disclosure are described in detail.

The present disclosure provides a polyfluorene-based anion exchange composite membrane including: a porous polymer support; and a polyfluorene-based anion exchange membrane or a polyfluorene-based anion exchange membrane having a cross-linked structure impregnated in the porous polymer support.

First, the porous polymer support may be selected from a group consisting of polyethylene, polypropylene, polytetrafluoroethylene, polyvinylidene fluoride, polyhexafluoropropylene and poly(perfluoroalkyl vinyl ether), although not being limited thereto.

In addition, the porous polymer support may more specifically have a pore size of 0.01-0.5 μm and a porosity of 50-90% for stable impregnation of an ionomer solution of the polyfluorene-based copolymer or the polyfluorene-based cross-linked copolymer.

In addition, while the porous polymer support is mostly hydrophobic, the surface of the porous polymer support may be fluorinated or hydrophilized in order to form an anion exchange membrane with no defect through stable impregnation of an ionomer polymer solution thereof by improving the affinity between the porous polymer support and the polyfluorene-based copolymer or the polyfluorene-based cross-linked copolymer.

Specifically, the fluorination is conducted as follows. After immersing the porous polymer support in an ethanol solution and then dispersing by sonication at −10° C. to 25° C., the porous polymer support is taken out and dried at room temperature. Subsequently, the dried porous polymer support is put in a vacuum chamber and an inert atmosphere is created inside the chamber by purging with nitrogen gas. Then, a fluorinated porous polymer support may be obtained by directly fluorinating the surface at room temperature for 5-60 minutes by supplying fluorine gas (500±15 ppm F₂/N₂ at atmospheric pressure) into the vacuum chamber at a rate of 1 L/min. The residual fluorine gas is removed with nitrogen gas using a scrubber filled with activated carbon.

And, the hydrophilization may be conducted by coating the surface of the porous polymer support with a C₁₋₃ hydrophilic alkylalcohol or a hydrophilic polymer such as dopamine or polyvinyl alcohol.

In addition, the polyfluorene-based anion exchange membrane may be a polyfluorene-based copolymer ionomer having a repeating unit represented by <Chemical Formula 1>.

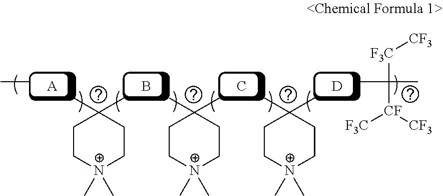

In Chemical Formula 1,

each of A, B, C and D segments is independently a compound selected from the following formulas, which may be identical to or different from each other:

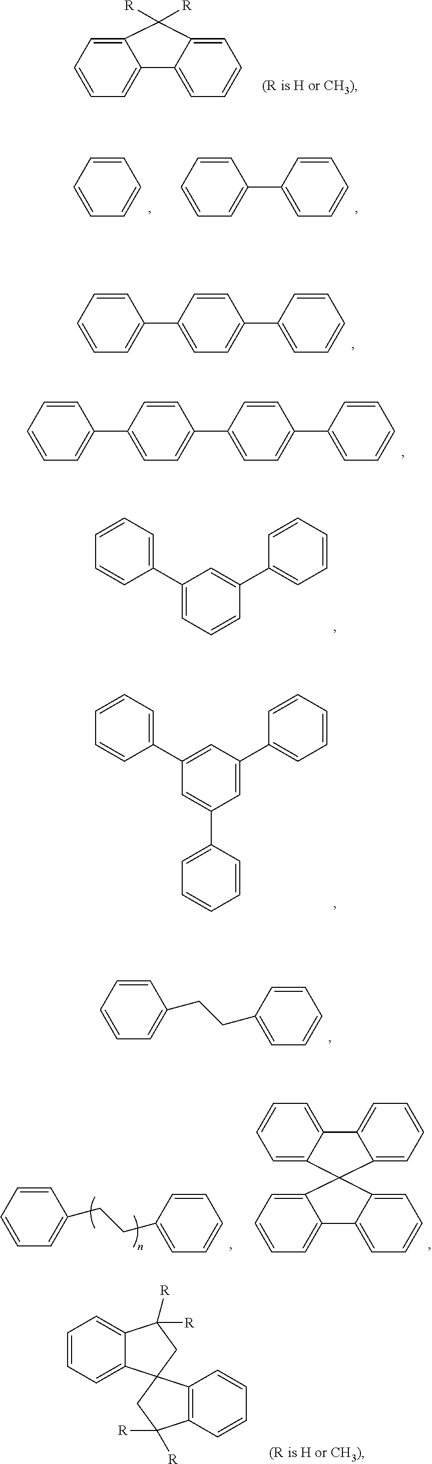

at least one of them being

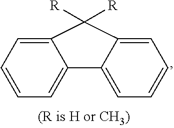

and

x, y, z and m are molar ratios in the repeating unit of the polymer ionomer x+y+z+m=1).

The polyfluorene-based copolymer ionomer having a repeating unit represented by <Chemical Formula 1>has already been disclosed in Novel polyfluorene-based copolymer ionomer, anion exchange membrane and method for preparing same (Korean Patent Publication No. 10-2021-0071810) by the inventors of the present disclosure. A polyfluorene-based copolymer ionomer prepared by the method is used in the present disclosure.

In addition, the polyfluorene-based anion exchange membrane having a cross-linked structure may be a polyfluorene-based cross-linked copolymer selected from copolymers having a cross-linked structure represented by <Chemical Formula 2> to <Chemical Formula 6>.

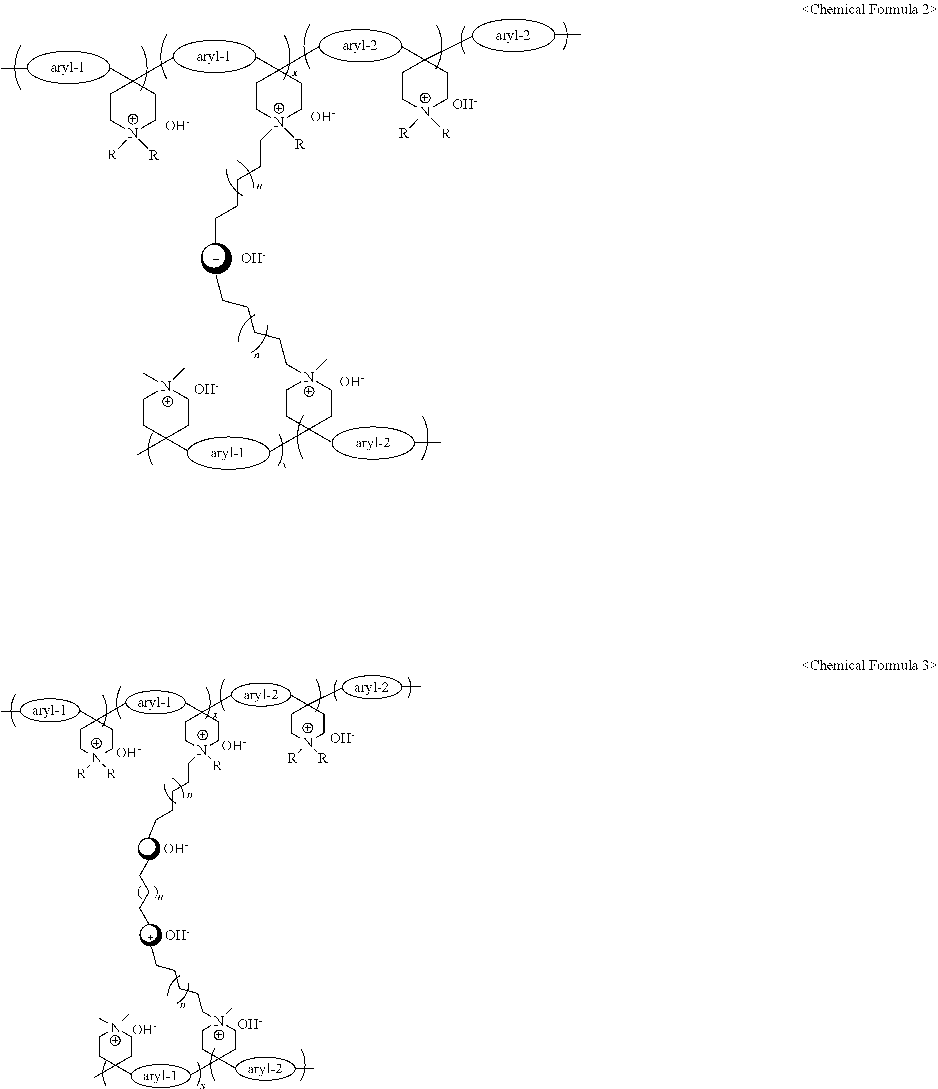

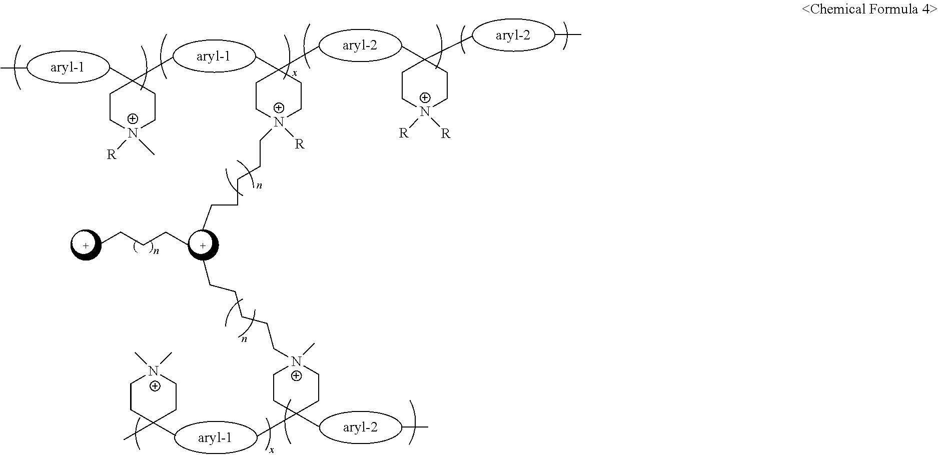

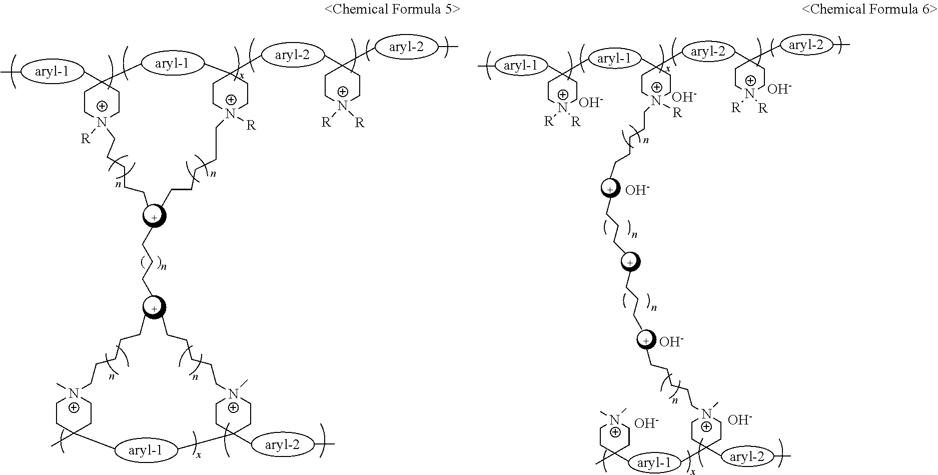

In <Chemical Formula 2> to <Chemical Formula 6>, each of aryl-1 and aryl-2 is independently selected from a group consisting of fluorenyl, phenyl, biphenyl, terphenyl and quaterphenyl, at least one of them being fluorenyl,

R is H or CH₃,

x indicates crosslinking degree,

[symbol] indicates an ammonium-based crosslinking agent, and

n is an integer from 1 to 15.

The polyfluorene-based cross-linked copolymer having a cross-linked structure selected from those represented by <Chemical Formula 2> to <Chemical

Formula 6>was prepared by crosslinking a polyfluorene-based copolymer such as poly(fluorene-co-terphenyl N-methylpiperidine) [PFTM] disclosed in Korean Patent Publication No. 10-2021-0071810 with a compound having at least one ammonium cation.

In <Chemical Formula 2> to <Chemical Formula 6>, the x which indicates crosslinking degree may be adjusted with the amount of a multi-ammonium compound having at least one ammonium cation used as the crosslinking agent. The crosslinking degree may be specifically 5-20%. If the crosslinking degree is lower than 5%, the improvement of physical properties through crosslinking may be insignificant. And, if the crosslinking degree exceeds 20%, the cross-linked copolymer may not be completely dissolved in an organic solvent and crosslinking may not occur.

In addition, the present disclosure provides a method for preparing a polyfluorene-based anion exchange composite membrane, which includes: (I) a step of preparing a porous polymer support; (II) a step of obtaining an ionomer solution by adding a cosolvent to a polymer solution wherein the polyfluorene-based copolymer represented by <Chemical Formula 1> or the polyfluorene-based cross-linked copolymer selected from those represented by <Chemical Formula 2> to <Chemical Formula 6> is dissolved in an organic solvent; and (III) a step of casting the ionomer solution on a porous polymer support and then impregnating and drying the same.

The surface of the porous polymer support of the step (I) may be fluorinated or hydrophilized according to the method described above.

In addition, the organic solvent of the step (II) may be N-methylpyrrolidone, dimethylacetamide, dimethyl sulfoxide or dimethylformamide, specifically dimethyl sulfoxide.

In addition, according to the present disclosure, an ionomer polymer solution is obtained by adding a cosolvent to a polymer solution wherein the polyfluorene-based copolymer represented by <Chemical Formula 1> or the polyfluorene-based cross-linked copolymer selected from those represented by <Chemical Formula 2> to <Chemical Formula 6> is dissolved in an organic solvent in order to improve the impregnation of the ionomer polymer solution in the porous polymer support during the composite membrane preparation process. This is the critical technical feature of the method for preparing an anion exchange composite membrane according to the present disclosure. Because the composite membrane can be obtained by a simple method of casting the polymer solution on the porous polymer support, the preparation process is simple and large-scale production is possible using a high-concentration solution.

The inventors of the present disclosure have measured the contact angle of various organic solvents during the procedure of selecting the cosolvent and have calculated the interfacial tension with the porous polymer support. It has been found out that methanol, ethanol or isopropyl alcohol, specifically ethanol, can be used as the cosolvent.

Specifically, the amount of the cosolvent added in the step (II) may be 2-25 wt % based on the polymer solution. If the amount of the cosolvent is less than 2 wt % based on the polymer solution, the ionomer polymer solution may not be easily impregnated in the porous polymer support. And, if the amount exceeds 25 wt %, it may be difficult to obtain a high-concentration polymer solution.

In addition, the present disclosure provides a membrane electrode assembly for an alkaline fuel cell, which includes the polyfluorene-based anion exchange composite membrane.

In addition, the present disclosure provides an alkaline fuel cell including the polyfluorene-based anion exchange composite membrane.

In addition, the present disclosure provides a water electrolysis device including the polyfluorene-based anion exchange composite membrane.

Hereinafter, the examples and comparative examples of the present disclosure are described specifically referring to the attached drawings.

### (Preparation Example) Preparation of Polyfluorene-Based Copolymer Ionomer (PFTP)

After adding 9,9′-dimethylfluorene (0.2914 g, 1.5 mmol) as a monomer and terphenyl (3.105 g, 13.5 mmol) and 1-methyl-4-piperidone (1.919 mL, 16.5 mmol, 1.1 eq) as comonomers to a two-necked flask, a solution was formed by adding dichloromethane (13 mL) and dissolving the monomers through stirring. After cooling the solution to 1° C., a viscous solution was obtained by slowly adding a mixture of trifluoroacetic acid (1.8 mL, −1.5 eq) and trifluoromethanesulfonic acid (12 mL, 9 eq) to the solution and stirring the mixture for 24 hours. A poly(fluorene-co-terphenyl-N-methylpiperidine) in solid form was prepared by precipitating the viscous solution with a 2 M NaOH solution, washing several times with deionized water and drying in an oven at 80° C. (yield>95%), and it was named PFTM.

Next, a polymer solution was obtained by dissolving the prepared PFTM (4 g) in a mixture of dimethyl sulfoxide (40 mL) and trifluoroacetic acid (0.5 mL) as a cosolvent at 80° C., and it was cooled to room temperature. Subsequently, a quaternary piperidinium salt was formed by adding K₂CO₃ (2.5 g) and iodomethane (2 mL, 3 eq) to the polymer solution and conducting reaction for 48 hours. Next, a poly(fluorene-co-terphenyl-N,N-dimethylpiperidinium) copolymer ionomer in solid form was prepared by precipitating the polymer solution with ethyl acetate, followed by filtering, washing several times with deionized water and drying in a vacuum oven at 80° C. for 24 hours (yield>90%), and it was named PFTP.

### Example 1] PREPARATION of Anion Exchange Composite Membrane (RCM)

A porous polyethylene support (W-PE) was prepared (purchased from W-Scope, thickness=10 μm or 20 μm). An ionomer solution was obtained by adding 3.3 wt % of ethanol as a cosolvent to a 10 wt % polymer solution wherein the PFTP obtained in Preparation Example was dissolved in dimethyl sulfoxide. After fixing the porous polyethylene support (which may be fluorinated or hydrophilized according to the method described above) on a glass plate, the ionomer solution was spread uniformly on the support using a syringe for impregnation. Then, an anion exchange composite membrane (3.3% PFTP@W-PE) was prepared by drying in an oven at 80° C. for 24 hours and then drying further in a vacuum oven at 80° C. for 24 hours.

### Example 2] Preparation of Anion Exchange Composite Membrane (RCM)

An anion exchange composite membrane was prepared in the same manner as in Example 1 except that an ionomer solution was obtained by adding 10 wt % of ethanol based on the polymer solution (10% PFTP@W-PE).

### Example 3] Preparation of Anion Exchange Composite Membrane (RCM)

An anion exchange composite membrane was prepared in the same manner as in Example 1 except that an ionomer solution was obtained by adding 15 wt % of ethanol based on the polymer solution (15% PFTP@W-PE).

### Example 4] Preparation of Anion Exchange Composite Membrane (RCM)

An anion exchange composite membrane was prepared in the same manner as in Example 1 except that an ionomer solution was obtained by adding 20 wt % of ethanol based on the polymer solution (20% PFTP@W-PE).

### Example 5] Preparation of Anion Exchange Composite Membrane (RCM)

An anion exchange composite membrane was prepared in the same manner as in Example 1 except that an ionomer solution was obtained by adding 25 wt % of ethanol based on the polymer solution (25% PFTP@W-PE).

### Comparative Example 1] Preparation of Anion Exchange Membrane

A 3.2 wt % polymer solution was prepared by dissolving the PFTP obtained in Preparation Example in dimethyl sulfoxide. Subsequently, after collecting the polymer solution with a syringe and filtering with a 0.4-μm filter, the resulting transparent solution was cast on a 14×21 cm glass plate. A polyfluorene-based anion exchange membrane was obtained by slowly removing the solvent by drying the cast solution in an oven at 85° C. for 24 hours and then completely removing the solvent by heating in a vacuum oven at 150° C. for 24 hours (PFTP single membrane).

### Comparative Example 2] Preparation of Anion Exchange Composite Membrane (RCM)

An anion exchange composite membrane was prepared in the same manner as in Example 1 except that ethanol was not added as a cosolvent (PFTP@W-PE).

### Comparative Example 3] Preparation of Anion Exchange Composite Membrane (RCM)

An anion exchange composite membrane was prepared in the same manner as in Example 1 except that a porous polymer support purchased from S was used (PFTP@S-PE).

### Test Example

The mechanical properties, morphology, ion exchange performance, water uptake, swelling rate, ionic conductivity, fuel cell performance, etc. of the anion exchange composite membranes prepared in Examples 1-3 and Comparative Examples 1-3 were evaluated and measured by the method described in Korean Patent Publication No. 10-2021-0071810 by the inventors of the present disclosure.

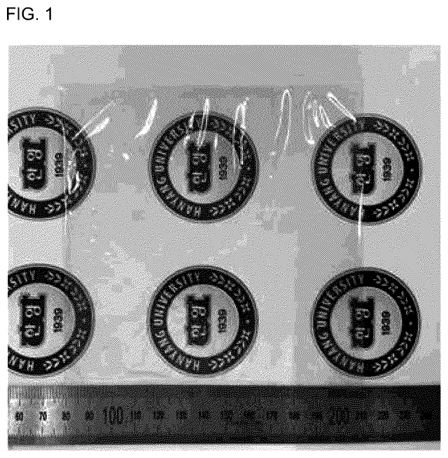

FIG. 1 shows the photographic image of the polyfluorene-based anion exchange composite membrane obtained according to an exemplary embodiment of the present disclosure.

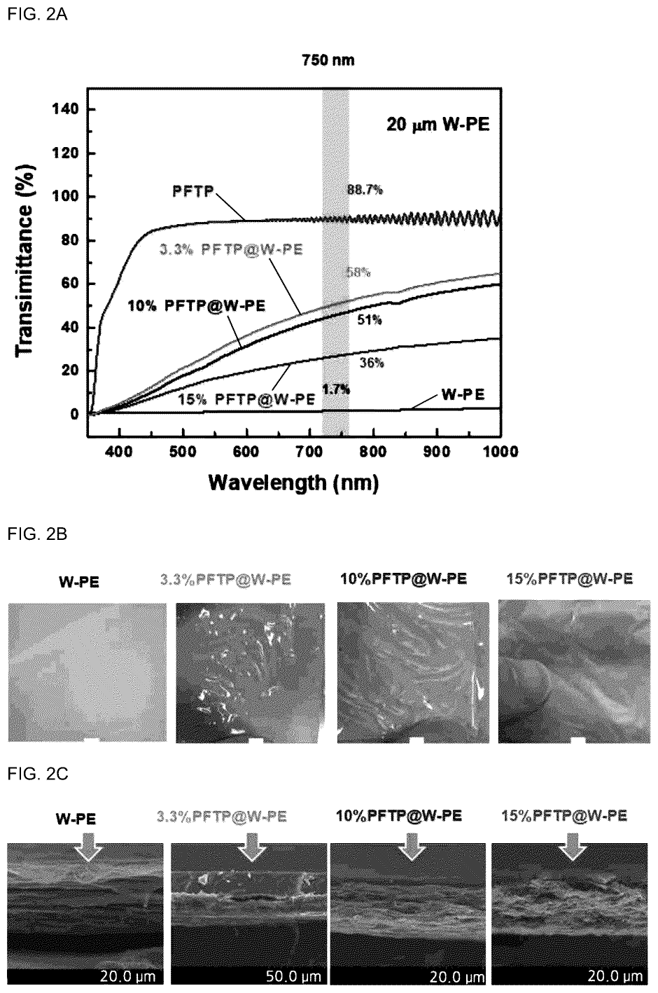

FIGS. 2A to 2C show the transmittance of the anion exchange composite membranes prepared in Examples 1-3, the anion exchange membrane prepared in Comparative Example 1 and a porous polyethylene support as a control group (thickness=20 μm) [(UV transmittance measurement result (FIG. 2A), photographic images (FIG. 2B), scanning electron microscopy (SEM) images (FIG. 2C)]. It can be seen that the transmittance is increased and the degree of impregnation is improved when ethanol was used as a cosolvent.

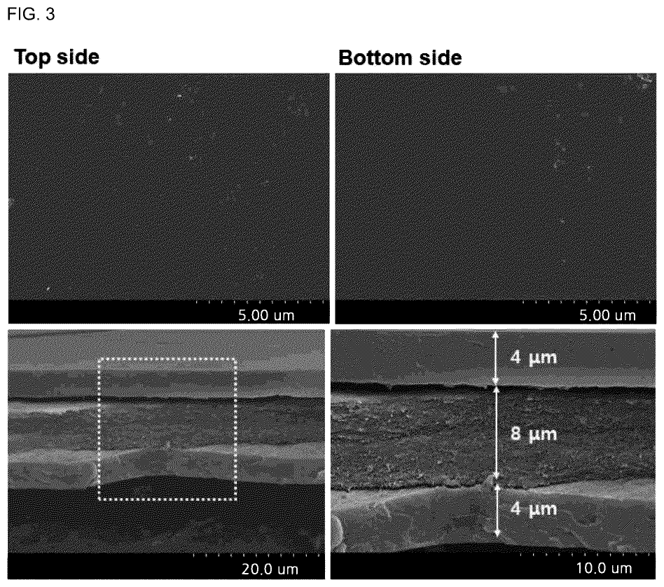

FIG. 3 shows the surface and cross-sectional scanning electron microscopy (SEM) images of the anion exchange composite membrane prepared in Example 2.

As seen from FIG. 3, the surface of the anion exchange composite membrane prepared in Example 2 was formed uniformly without cracking. In addition, it can be seen from the cross-sectional images that the support is located at the center and coated uniformly up and down with the same thickness.

In addition, the measurement result of the ion-exchange capacity (IEC), water uptake (WU) at 80° C., swelling rate (SR), ionic conductivity (a) at 30° C., tensile strength (TS), elongation at break (EB) and transmittance (T) of the anion exchange composite membrane prepared in Example 2 and the anion exchange membrane prepared in Comparative Example 1 is shown in Table 1.

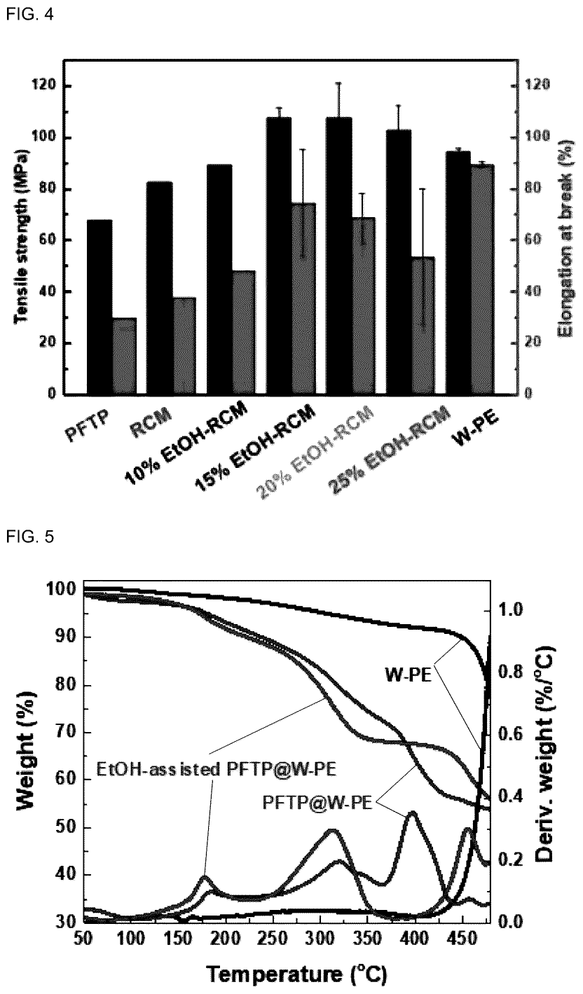

FIG. 4 shows the mechanical properties of the anion exchange composite membranes prepared in Examples 2-5, the anion exchange membrane prepared in Comparative Example 1, the anion exchange composite membrane prepared in Comparative Example 2 and a porous polyethylene support as a control group.

FIG. 5 shows the thermogravimetric analysis (TGA) result showing the thermal stability of the anion exchange composite membrane prepared in Example 2, the anion exchange composite membrane prepared in Comparative Example 2 and a porous polyethylene support as a control group.

TABLE 1

| | | | In-plane | Through-place | | TS (MPa)/ | |
|---|---|---|---|---|---|---|---|
| Samples | IEC (mmolg⁻¹) | WU (%) | SR (%) | SR (%) | σ | EB (%) | T (%) |
| Example 2^{a} | 2.36 | 25 | 17 | 7 | 15 | 91/49 | 100% |
| Example 2^{b} | 2.35 | 20 | 16 | 5 | 32 | 121/53 | ~84% |
| Comparative | 2.78 | 76 | 24 | 27 | 65 | 68/30 | ~100% |
| Example 2 | | | | | | | |

^{a}W-PE thickness = 20 μm,
^{b}W-PE thickness = 10 μm

As seen from Table 1 and FIG. 4, the anion exchange composite membrane prepared according to the present disclosure exhibits superior mechanical properties with tensile strength increased by 1.7 times or more and elongation at break increased by 2.5 times or more as compared to the commercial anion exchange composite membrane or the single-membrane type anion exchange membrane, probably because of the greatly improved degree of impregnation due to the addition of the cosolvent such as ethanol during the preparation of the composite membrane.

In addition, it can be seen from the thermogravimetric analysis result shown in FIG. 5 that the anion exchange composite membrane prepared according to the present disclosure is also thermally stable.

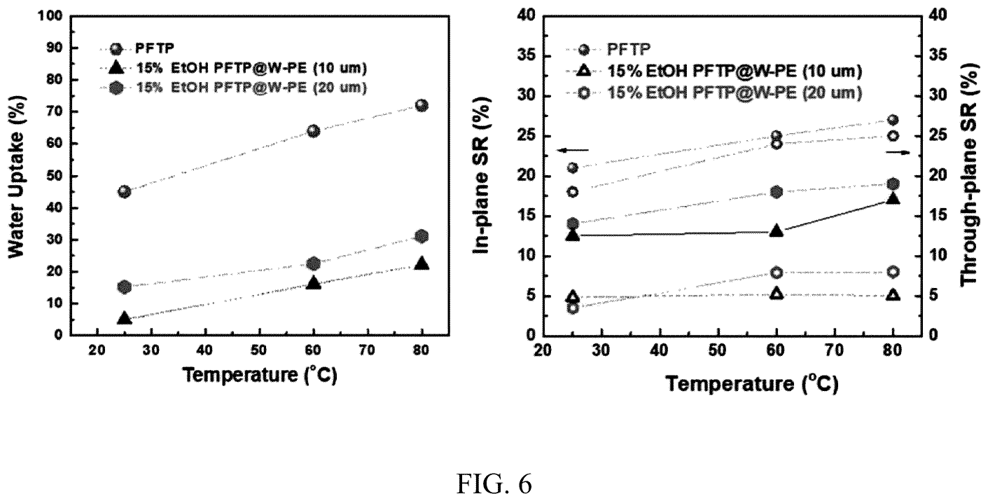

FIG. 6 shows the dimensional stability of the anion exchange composite membrane prepared in Example 3 and the anion exchange membrane prepared in Comparative Example 1. It can be seen that the anion exchange composite membrane shows very superior dimensional stability with water uptake decreased to ⅓ or less and swelling rate decreased to ⅕ or less as compared to the single-membrane type anion exchange membrane.

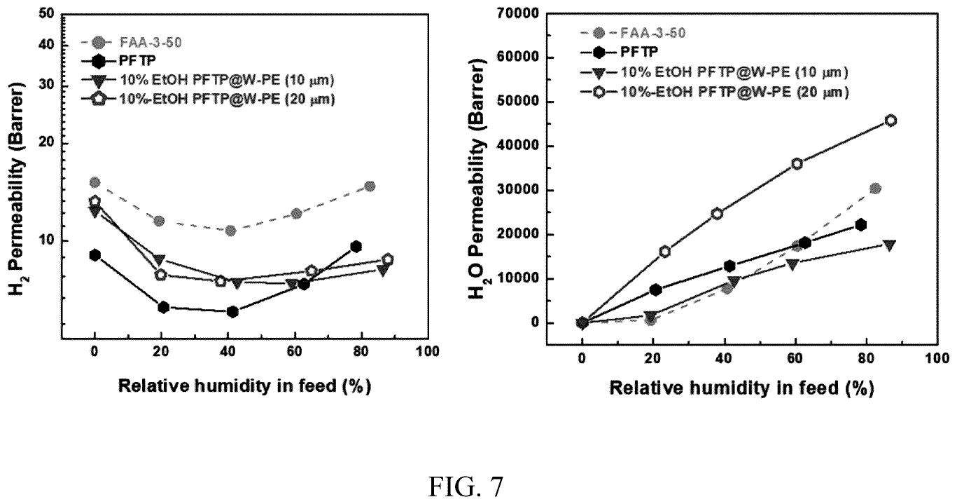

FIG. 7 shows the hydrogen permeability and water permeability of the anion exchange composite membrane prepared in Example 2, the anion exchange membrane prepared in Comparative Example 1 and a commercial anion exchange membrane (FAA-3-50) as a control group. It is expected that the crossover of fuel will be decreased since the anion exchange composite membrane showed very low hydrogen permeability under the normal fuel cell operation condition of 75-100% relative humidity (RH).

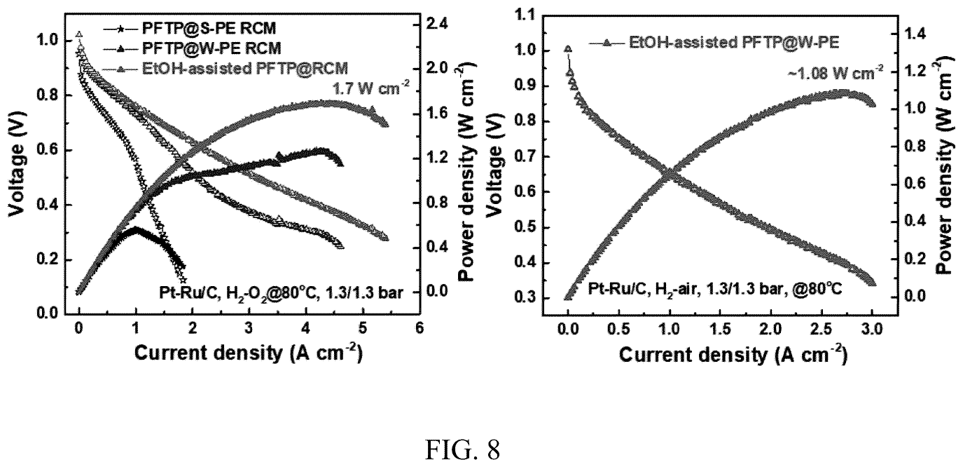

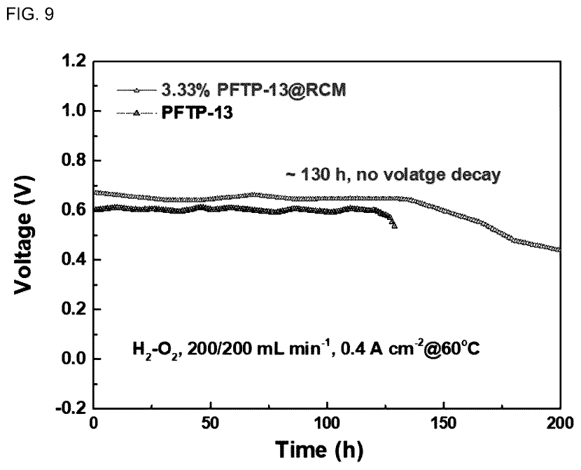

FIG. 8 shows the fuel cell performance of the anion exchange composite membrane prepared in Example 2 and the anion exchange composite membranes prepared in Comparative Examples 2 and 3. The anion exchange composite membrane prepared in Example 2 showed superior performance and ideal curves even under the condition of platinum-group metal catalyst electrodes (Pt—Ru/C anode, Pt/C cathode) and 80° C., NC 1.3/1.3 backpressure, H₂—O₂ or H₂-air (CO₂ free) atmosphere. It is thought that this result is caused by enhanced ion transfer due to significantly increased impregnation owing to the addition of the cosolvent such as ethanol during the preparation of the composite membrane.

FIG. 9 shows the fuel cell performance of the anion exchange composite membrane prepared in Example 1 and the anion exchange membrane prepared in Comparative Example 1. The anion exchange composite membrane according to the present disclosure also showed superior durability as compared to the single-membrane type anion exchange membrane without voltage drop for about 130 hours or longer.

Therefore, the anion exchange composite membrane according to the present disclosure can be produced in large scale because the degree of impregnation is improved greatly by the addition of a cosolvent during the preparation process and can be applied to alkaline fuel cells, water electrolysis devices, carbon dioxide reduction, metal-air batteries, etc. since mechanical properties, dimensional stability, durability, long-term stability, etc. are improved remarkably.

1. A polyfluorene-based anion exchange composite membrane comprising:
a porous polymer support; and
a polyfluorene-based anion exchange membrane or a polyfluorene-based anion exchange membrane having a cross-linked structure impregnated in the porous polymer support.

2. The polyfluorene-based anion exchange composite membrane according to claim 1, wherein the porous polymer support is selected from a group consisting of polyethylene, polypropylene, polytetrafluoroethylene, polyvinylidene fluoride, polyhexafluoropropylene and poly(perfluoroalkyl vinyl ether).

3. The polyfluorene-based anion exchange composite membrane according to claim 1, wherein the porous polymer support has a pore size of 0.01-0.5 lim and a porosity of 50-90%.

4. The polyfluorene-based anion exchange composite membrane according to claim 1, wherein the porous polymer support is fluorinated or hydrophilized.

5. The polyfluorene-based anion exchange composite membrane according to claim 1, wherein the polyfluorene-based anion exchange membrane is a polyfluorene-based copolymer ionomer having a repeating unit represented by <Chemical Formula 1>: 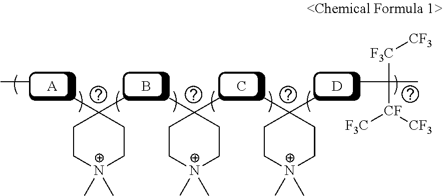
wherein
each of A, B, C and D segments is independently a compound selected from the following formulas, which may be identical to or different from each other: 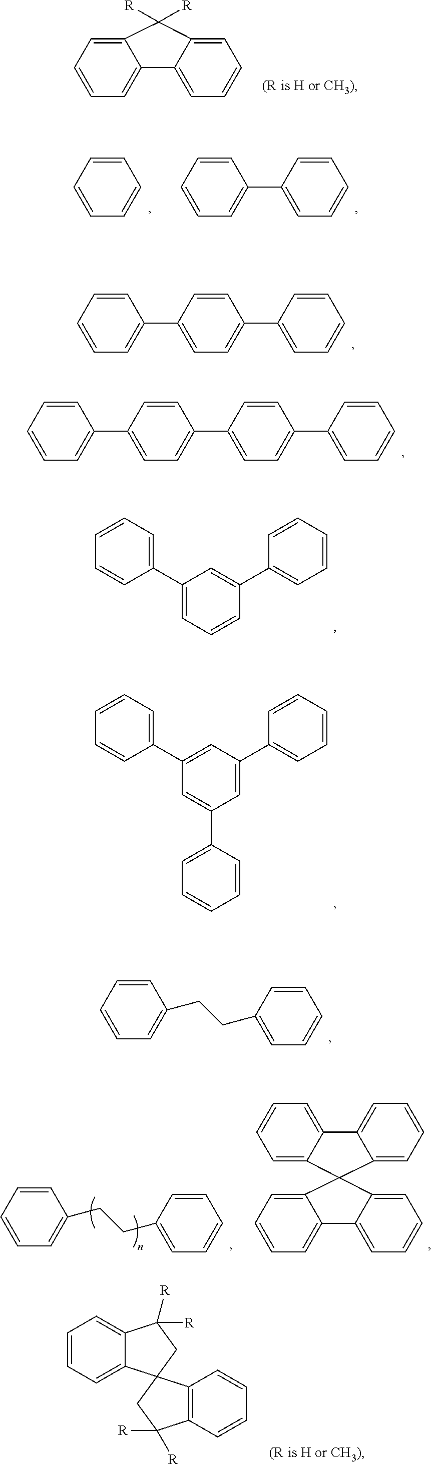
at least one of them being 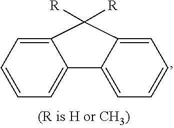
and x, y, z and m are molar ratios in the repeating unit of the polymer ionomer x+y+z+m=1).

6. The polyfluorene-based anion exchange composite membrane according to claim 1, wherein the polyfluorene-based anion exchange membrane having a cross-linked structure is a polyfluorene-based cross-linked copolymer selected from copolymers having a cross-linked structure represented by <Chemical Formula 2> to <Chemical Formula 6>: 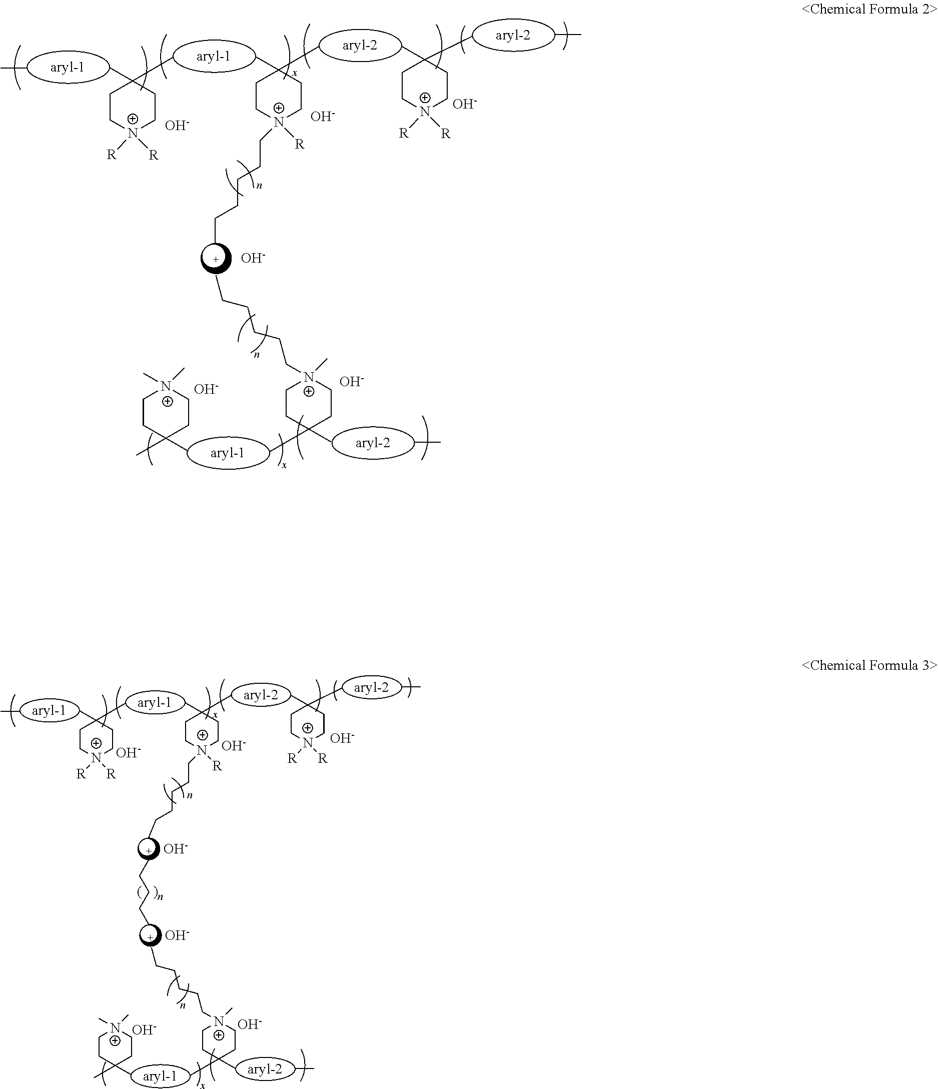 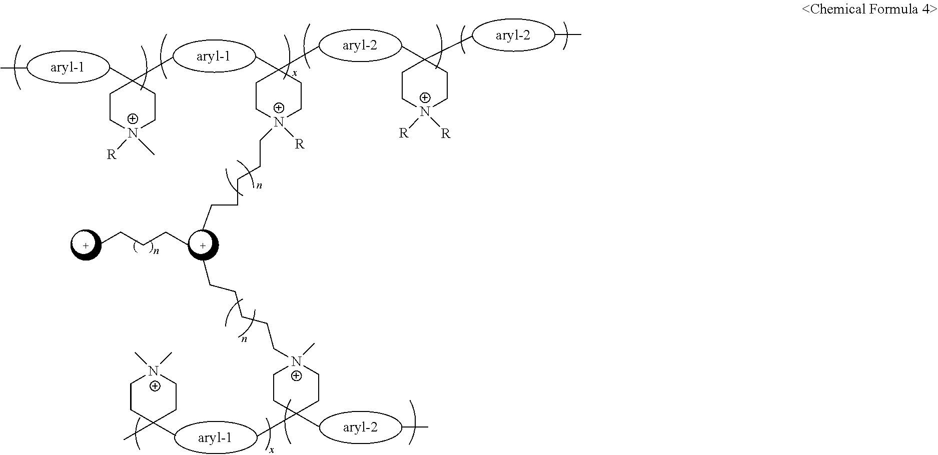 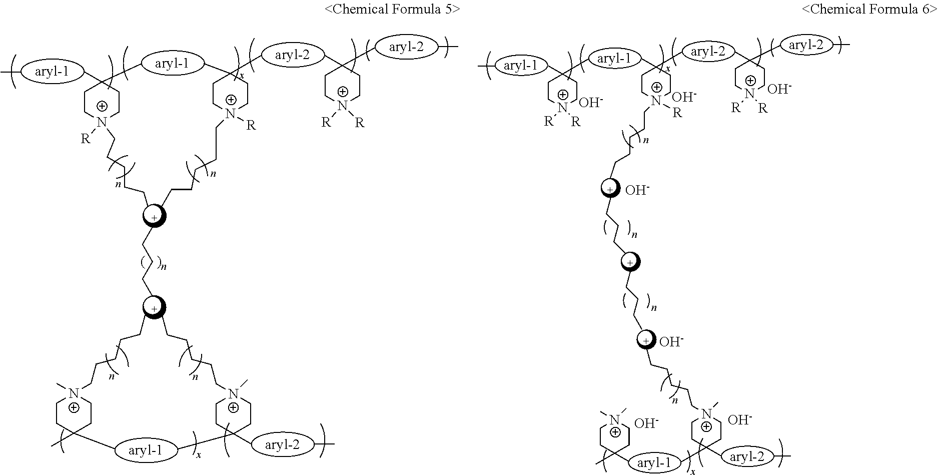
wherein
each of aryl-1 and aryl-2 is independently selected from a group consisting of fluorenyl, phenyl, biphenyl, terphenyl and quaterphenyl, at least one of them being fluorenyl,
R is H or CH₃,
x indicates crosslinking degree, [symbol]
Indicates an ammonium-based crosslinking agent, and
n is an integer from 1 to 15.

7. A method for preparing a polyfluorene-based anion exchange composite membrane, comprising:
(I) a step of preparing a porous polymer support;
(II) a step of obtaining an ionomer solution by adding a cosolvent to a polymer solution wherein the polyfluorene-based copolymer represented by <Chemical Formula 1> of claim 5 is dissolved in an organic solvent; and
(III) a step of casting the ionomer solution on a porous polymer support and then impregnating and drying the same.

8. The method for preparing a polyfluorene-based anion exchange composite membrane according to claim 7, wherein the surface of the porous polymer support of the step (I) is fluorinated or hydrophilized.

9. The method for preparing a polyfluorene-based anion exchange composite membrane according to claim 7, wherein the organic solvent of the step (II) is N-methylpyrrolidone, dimethylacetamide, dimethyl sulfoxide or dimethylformamide.

10. The method for preparing a polyfluorene-based anion exchange composite membrane according to claim 7, wherein the cosolvent of the step (II) is methanol, ethanol or isopropyl alcohol.

11. The method for preparing a polyfluorene-based anion exchange composite membrane according to claim 7, wherein the amount of the cosolvent added in the step (II) is 2-25 wt % based on the polymer solution.

12. A membrane electrode assembly for an alkaline fuel cell, comprising the polyfluorene-based anion exchange composite membrane according to claim 1.

13. An alkaline fuel cell comprising the polyfluorene-based anion exchange composite membrane according to claim 1.

14. A water electrolysis device comprising the polyfluorene-based anion exchange composite membrane according to claim 1.
